(19) United States
(12) Patent Application Publication
(10) Pub. No.: US 2024/0185599 A1
(43) Pub. Date: Jun. 6, 2024

(54) PALM TREE MAPPING

(71) Applicant: B.G. Negev Technologies and Applications Ltd., Beer Sheva (IL)

(72) Inventors: Galit Fuhrmann Alpert, Even Yehuda (IL); Dimitry KAGAN, Beer Sheva (IL); Michael Fire, Omer (IL)

(73) Assignee: B.G. Negev Technologies and Applications Ltd., Beer Sheva (IL)

(21) Appl. No.: 18/551,856

(22) PCT Filed: Mar. 17, 2022
(86) PCT No.: PCT/IB2022/052458

§ 371 Date: Sep. 21, 2023

Related U.S. Application Data
(60) Provisional application No. 63/163,888, filed on Mar. 21, 2021.

(51) Int. Cl. G06V 20/10; G06V 10/764

(52) U.S. Cl. CPC G06V 20/188; G06V 10/764

(57) ABSTRACT

A non-transitory computer readable medium for detection of objects of one or more given classes, the non-transitory computer readable medium stores instructions for: performing an aerial images based (AIB) detection to find multiple object locations; wherein the performing of the AIB detection comprises applying an AIB detection machine learning process on aerial images; performing a ground-level based (GLB) detection of the objects, based on the multiple object locations; wherein the performing of the GLB detection comprises applying a GLB detection machine learning process on ground-level images; and classifying, by a classification machine learning process, objects captured in the ground-level images to a plurality of classes, wherein the plurality of classes comprise the one or more given classes; and responding to the classifying, when finding one or more objects of the one or more given classes.

### CROSS REFERENCE BACKGROUND OF THE INVENTION

This application claims priority from US provisional patent filing date Mar. 21 2021, Ser. No. 63/163,888 which is incorporated herein by reference.

### BACKGROUND OF THE INVENTION

The Red Palm Weevil (also known as Rhynchophorus Ferrugineus, and Rhynchophorus Vulneratus) is a type of beetle that attacks palm trees and that has become an existential threat for palm trees around the world. The mechanism of infection involves the beetles laying eggs inside palm trees, with the eventual larvae feeding on the palm's tissue, thus creating tunnels inside the tree trunk that weaken its structure, finally causing extensive damage that results in decline and even breakage of the tree (see images 11 of FIG. 1).

Notably, the spread of beetles from one palm to another is estimated at up to 50 km per day thus rapidly spreading geographically and raising tremendous risks to spatially widespread tree locations. In fact, the Red Palm Weevil originated from tropical areas in Asia, yet it has evolved from being only a local problem into a worldwide concern in the past decades. In 2010, the Red Palm Weevil reached the U.S which in the following year was also invaded by its close relative species the South American Palm Weevil In 2011, it was detected in eight European countries, and it has spread further in the past decade. Today, according to the EPPO (European and Mediterranean Plant Protection Organization) datasheet, the Red Palm Weevil has spread to 85 different countries and regions worldwide. Without constant monitoring, the Red Palm Weevil will keep spreading further.

The financial implications of the extensive damage to palm trees are enormous, particularly to date and coconut growers. In fact, the Food and Agriculture Organization of the United Nations estimates that in 2023, the combined cost of pest management and replacement of damaged palm trees, in Spain and Italy alone, will reach 200 million Euro. Moreover, the Red Palm Weevil threat occurs to be not just financial, but also of injury to matter and individuals. In many countries around the world, palm trees are considered decorative trees planted in residential neighborhoods, and an infested tree has a higher likelihood of breaking down under strong winds, thus endangering human lives.

For example, in Israel, the Ministry of Agriculture has officially stated that it is just a matter of time until someone would be seriously injured from a collapsing infected palm. Importantly, early detection of palm tree infestation may save trees from irreversible damage. At those earlier stages, control methods could be used, most commonly by the application of insecticides. Thus, an accurate mapping of infestation hot zones is highly advisable to eradicate the pests efficiently, especially of privately planted palm trees whose locations are not documented officially. In the past couple of decades, various Red Palm Weevil detection methods were proposed.

There have been considerable efforts based on acoustic detection as well as methods utilizing canines. However, these methods do not deal with the mapping of tree locations. Moreover, most of these attempts fall from being applicable at a large scale as well as in urban areas, where many homeowners are unaware of the danger and do not realize infestation until it is too late for treatment.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of an aerial image;

FIG. 2 illustrates an example of information processing;

FIG. 3 illustrates an example of images acquired and/or processed during steps of a method;

FIG. 4 illustrates an example of a map;

FIG. 5 illustrates an example of maps;

FIG. 6 illustrates an example of images;

FIG. 7 illustrates an example of images;

FIG. 8 illustrates an example of images;

FIG. 9 illustrates an example of images;

FIG. 10 illustrates an example of a method;

FIG. 11 illustrates an example of a method;

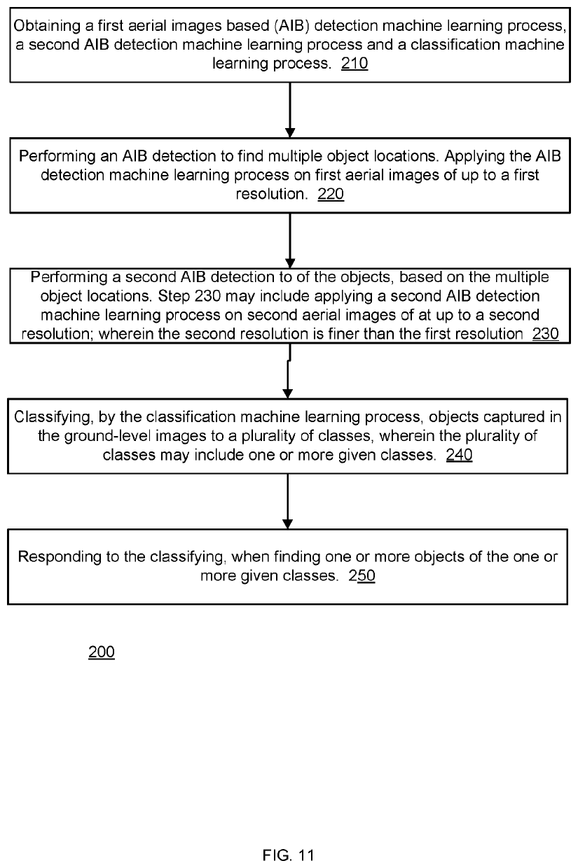

FIG. 12 illustrates an example of a method;

FIG. 13 illustrates an example of a computerized system.

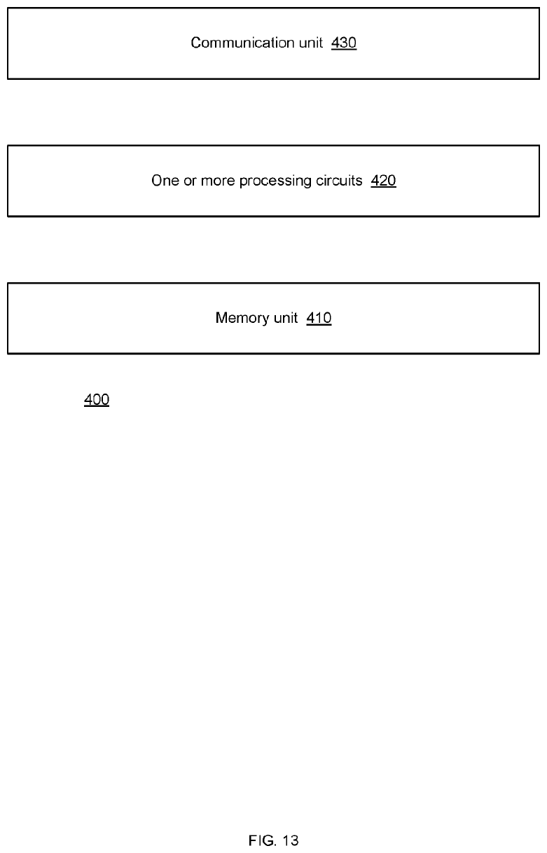

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There is provided a method for large scale mapping and detection of Red Palm Weevil infested palms using state-of-the-art deep learning algorithms. Our approach combines both aerial and street view images. the inventors utilize the aerial images to reduce the number of required costly street view images and use street view images only where there are palm trees. Aerial images show greater area and are cheaper than street view images, but they are lower resolution and only show objects from above. On the other hand, street view images provide higher resolution and are available at various angles. Aerial images are suitable for identifying of regions with high concentrations of palms while street view images for the actual detection of infested palm trees. The initial aerial screening reduces costs of using street view images, making the proposed method sustainable. the inventors believe our proposed large-scale approach may be of high financial importance to countries worldwide, reduce risks of injury in urban areas, and massively save agriculture fields.

Our algorithm is based on the following steps: the inventors collect and label aerial and street-level images of palm trees. the inventors then train three deep-learning models for palm detection on aerial images, palm detection from street-level images, and finally an infested palm classifier on the detected images. Next, the inventors utilize the trained aerial palm detection model to identify palm trees downloaded from Google Maps aerial data and map the identified palm tree locations into spatial coordinates. For each detected tree, the inventors retrieve the nearest street view panorama from Google street view and compute the camera heading that centers on the palm tree detected in the aerial images. These tree centered images are used for the detection of palms by our street-level palm detection model. Finally, the inventors apply a novel infested palm tree classifier to uncover infested Red Palm Weevil palm trees and highlight hotspots of palm trees with a high probability of tree infestation.

We analyzed more than 100,000 images mapping palm trees utilizing both aerial and street-level imagery. the inventors demonstrate that a combination of aerial and street-level imagery produces a cost efficient method for mapping specific objects. the inventors apply deep-learning based image processing algorithms to demonstrate that it is possible to identify infested palm trees based on low quality street view images. Additionally, the inventors show that it is possible to monitor the progress of the infestation in many cases. the inventors demonstrate that there is an opportunity to revolutionize Red Palm Weevil management using computer vision.

The multiple key contributions of this study are the following:
A novel framework utilizes deep learning and imagery data to automatically quickly and cost efficiently detect Red Palm Weevil infested palm trees over large geographic areas.
An approach for palm tree mapping in urban areas using aerial or street level images that allows municipalities to efficiently (quickly at low cost) perform preventive chemical treatments.
We present a novel application for street view images; the inventors demonstrate that street view can be utilized to detect infested plants.
We demonstrate that the inventors can monitor palm tree degradation and inspect changes in the infestation status over time.
The presented approach can be utilized to identify regions in which there is a higher probability for infestation, and as a result, should be surveilled more carefully.

### Related Work

In this study, the inventors offer a novel framework to automatically detect Red Palm Weevil infested palm trees on large scale geographic areas, which is also applicable for urban regions. Both these points are currently not supported using existing methodologies. the inventors therefore cover here works related to both these novel points offered in the current manuscript, namely large scale detection and urban mapping.

### Large Scale Detection of Red Palm Weevil Infestation

As noted in the Introduction, early detection of palm tree infestation is critical in order to allow treatment that may save trees from irreversible damage. There are various Red Palm Weevil infestation detection methods, all of which are geographically limited by scale. The most straightforward method is by visually inspecting tree by tree. However, this type of method is naturally not feasible on a large scale. To overcome this limitation, other methods were proposed. One such possibility that was raised was of using trained animals for odor-based detection. Specifically, research indicated that insects emit chemicals into the air and that dogs could successfully detect Weevil infested palm trees. However, this approach also could not be applicable at large scales. Another approach is sound-based detection, relying on the fact that the Red Palm Weevil larvae produce sounds while feeding through the palm tree. Multiple such frameworks were suggested over the years. There is no doubt that the acoustic method is feasible, yet it too requires approaching each tree individually, thus limiting its scale of performance. The usage of infrared and thermal imagery is commonly used to detect various pests and diseases in plants and trees. There are multiple examples of various plants such as tomato, tea, orange, and cucumber. For instance, de Castro et al. utilized low altitude aerial imaging to identify laurel wilt disease in avocado. There are indications that like in other trees and plants, an approach based on thermal imaging could be used to detect infested palm trees. However, at its current state, it is only suitable for detecting infestations in open areas, and its detection accuracy is lower than detection by either dogs or acoustic based approaches. In summary, monitoring palms at a large scale is considered a challenging and presumably costly task, especially in urban areas with a large variance in age, spices, growth, and vegetation condition.

### Mapping Objects in Urban Environments Based on Street View Images

Google Street View has been used in multiple applications for urban street mapping, with applications to a variety of domains. Below is a brief introduction to several such sample studies. In 2015, Balali et al. created an inventory of street signs using imagery data collected from Google Street View. To detect and classify the collected dataset of signs, they used HOG (Histogram of Oriented Gradients) along with color, using a linear (SVM) classifier. In a follow-up study, Campbell et al. used deep learning to map street signs ina sample city (The City of Greater Geelong), demonstrating that the modelcan automatically detect two different types of street signs (Stop and Give Way signs). In 2017, Gebru et al. used 50 million Google Street View images to estimate the socioeconomic status of 200 US cities. They used deep learning to detect the make, model, and year of vehicles in each area. The data analysis revealed an interesting correlation between car information and demographic data, including voter preferences, ethnicity, etc. The same year, Seiferling et al. used Google Street View to quantify tree coverage in urban areas. To estimate tree coverage, they used a multi-step image segmentation model on the collected data. Wegner et al. presented a system for the detection and classification of publicly visible objects. To this end, they combined street and aerial imagery. They demonstrated the potential of their system by detecting different types of trees.

Wegner et al. presented two systems, one for tree detection and another for classification. In 2018, Branson et al. continued the work of Wegner et al. presenting a method for mapping the tree speciesusing street imagery using a single system.

They combined both street and aerial imagery to train a CNN (Convolutional Neural Network)-based classifier to classify tree images into 140 different tree species. Their important work emphasizes the vast potential of using advanced technologies on online data sources in order to map and classify vegetation in urban areas. Li et al. used Google Street View to quantify the shade trees created. Cai et al. utilized Google Street View to develop an improved deep learning model fortree segmentation. In another interesting study of urban mapping, publishedin 2019, Helbich et al. used Google Street View, satellite imagery, and deep learning to map green (vegetation) and blue (waterscapes) spaces in Beijing in order to explore correlations between green and blue spaces to mental health among the elderly population.

Law et al. used street view and satellite imagery and deep learning to extract visual features from satellite and street view images in order to estimate housed prices. Their research was driven by the assumption that house prices are affected by the neighborhood amenities and other features that can be quantified using images. Recently, Tang et al. presented an approach for greenway planning. They utilized multiple data sources, including street view images to measure visible greenery.

These and other studies demonstrate the tremendous potential of urban mapping for an amazingly wide range of applications, including those of tree mapping, as the one offered in our study

### Methods and Experiments

In this study, the inventors strive to demonstrate the potential of automatically detecting Red Palm Weevil and South American Palm Weevil infested palm trees at large scales using street view imagery and computer vision algorithms. The rationale is to provide a basic 2-step approach in order to map all palm trees ina given area, using a tree detection model and a subsequent classifier to identify infested trees amongst them. Initially, the inventors implemented the 2-step approach only using street view images. After multiple empirical tests, the inventors realized that although using only street view images work well for small areas, it may betoo expensive and inefficient to apply this method to a large city. In fact, since collecting and processing images may carry considerable costs in terms of both money and time, the efficiency of the palm-tree detection method in use is utterly important.

Thus, to improve the efficiency of the proposed method, the inventors added an additional pre-processing step prior to palm tree detection from street-level images. In this pre-processing step, the inventors first detect palm trees from aerial images and only then proceed to detection from street level; the advantage being that while street-level imagery can be used for object detection in a radius of several meters, a single aerial image can be used for preliminary detection of objects in much broader areas. This allows an efficient large scale scanning of areas, taking advantage of the trees being large enough objects to be detected from satellite images. Importantly, aerial detection provides precise coordinates that can later be used for flagging towards treatment actions. This is in contrast to street view imagery, which provides coordinates of the camera in use, along with thecamera heading, but not the actual coordinates of the detected object.

The proposed method is thus composed of the following steps: (a) palm tree detection from aerial imagery, (b) palm tree detection from street view images in urban environment, and (c) classification of detected palm trees into healthy/infested.

### Palm Tree Detection from Aerial Imagery

Data Collection. To train a palm tree detection model the inventors collecteda set of 257 aerial images containing palm trees. The inventors focused on images collected from Miami area in CA (US), an area known to have high densities and rich varieties of palm trees. The images were collected from the Miami Dade county imagery.

Creating a Training Set. The inventors created a training set by manually labeling 257 images containing a total of 1,028 palm trees,

Training an Aerial Palm Tree Detection Model. The inventors used the PyTorch library to apply transfer learning on a pre-trained Convolutional Neural Network (CNN). In order to achieve a better generalization of the model in use, the inventors increased the variance of the data by data augmentations in multiple dimensions. The model was pretrained on the COCO dataset, the standard training dataset used by PyTorch for object detection and segmentation problems. From the object detection pre-trained models provided by PyTorch, the inventors chose to use Faster R-CNN ResNet-50 FPN, which is an improved version of the model that achieves higher Average Recall (AR) and Average Precision (AP) without sacrificing speed, or memory and offers the fastest performance in terms of training and inference time. Training and inference time is critical since the inventors use a single RTX 2080 GPU on over 100,000 images. The model was evaluated using the Mean Average Precision (MAP) metric on a 20% validation set.

### Extracting Coordinates of Tree Object Locations

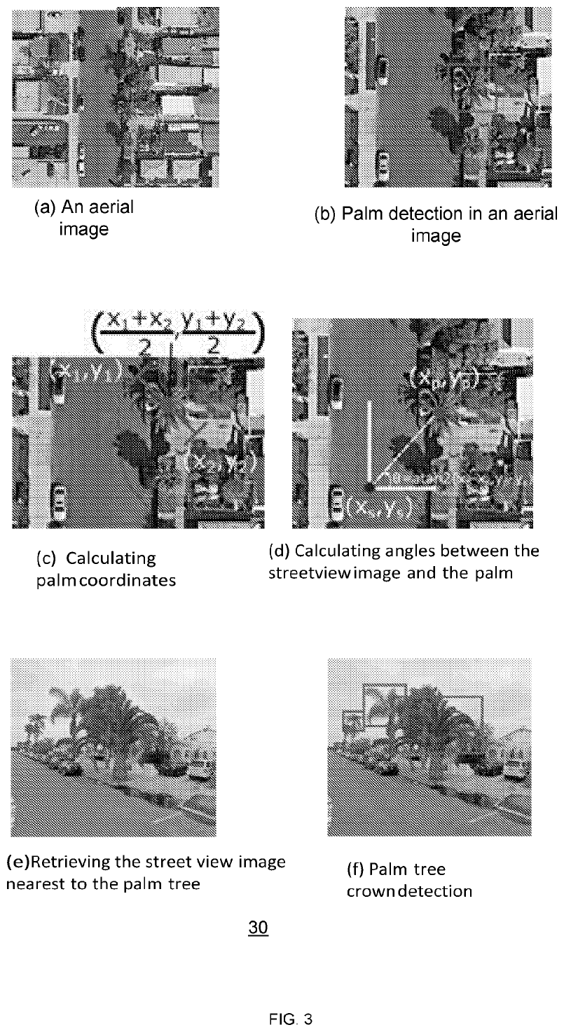

FIG. 3 includes size images collectively denoted 30-30(a), 30(b), 30(b), 30(d), 30(e) and 30(f).

Using the trained aerial detection model, method detected trees over wide urban areas (see FIG. 3(b)). To convert the output of the detection model from (x,y) coordinates, corresponding to image pixels, into actual physical locations, the inventors performed the following: First, since input images are given in the format of tiles, and tile border coordinates per image are known, the inventors mapped tile coordinates from Google coordinate format (EPSG:3857) onto WSG 84 coordinate system and calculated the bounds of the tile. The inventors then performed affine transformation to convert the detected palm trees bounding box boundaries onto WGS 84 coordinates. Finally, the inventors calculated the center of the bounding box to represent the coordinates of a palm tree location (see FIG. 3(c)).

### Palm Tree Detection from Street View Images in Urban Environments

The inventors trained an object detection model to detect palm trees from the collected street-level images.

Data Collection. To train a street view palm detection model the inventors first collected a set of 314 Street View images of palm trees. Images were collected using Google Street View, each image size was 640×640. In accordance with the collected data for the aerial detection model, the inventors focused on images collected from the same region of Miami-Dada county, CA.

Training the Street View Palm Detection Model. The inventors performed manual labeling of palms on the collected dataset, by drawing bounding boxes over palm tree crowns while minimizing background as much as possible. A total of 314 images, containing 888 palm trees, was used for training the model. Similarly to the aerial detection model, also here, the inventors applied transfer learning using Faster R-CNN ResNet-50 FPN pre-trained on COCO as our model, with the PyTorchlibrary. Data augmentations were also performed as for training the aerial detection model. The model was evaluated using the MAP metric on a 20% validation set.

### Localizing Palm Trees for Classification

To determine the physical location of the palm tree for subsequent classification, for each palm tree detected in the aerial images (denoted as (xₐₑᵣᵢₐₗ, yₐₑᵣᵢₐₗ)), the inventors sent an HTTP request to the Google Street View server and request the ID and coordinate of the nearest panorama to (xₐₑᵣᵢₐₗ, yₐₑᵣᵢₐₗ). Let (xₛₜᵣₑₑₜ, yₛₜᵣₑₑₜ) denote the retrieved panorama coordinates. Google Street View, by default, retrieves an image with the heading (camera angle) of 0° (the camera is angled to the North), where the heading is defined as the compass heading of the camera. the inventors calculate the required heading of the camera using the following equation (see FIG. 3(d)): heading=atan2(yₛₜᵣₑₑₜ−yₐₑᵣᵢₐₗ, xₛₜᵣₑₑₜ−xₐₑᵣᵢₐₗ)

Using the calculated heading for each palm tree, the inventors retrieve the corresponding street view image (see FIG. 3e). Finally, the inventors apply the palm tree crown detector to identify all the palm trees in the image (see FIG. 3(f)).

For each palm tree crown detected by the trained street-level palm crown detector, the method proceeded to predict whether it is healthy or infested.

### Classification of Detected Palm Trees into Healthy/Infested

To train a model for identifying whether detected palm trees are healthy or infected, the inventors used 70 images containing infested palm tree crowns. The inventors used only the palm crowns for classification, the logic being that since the resolution of palm crowns is relatively low in Street View images (less than 640×640) it should be easier to detect infestation symptoms in crowns than in the tree trunk in low resolution images. The inventors used the same images that were manually labeled for training the palm crown detection model. During the process of data, the inventors realized that the Palm Beach data did not have samples of Date Palms. Thus, to add Date Palms to thedata, the inventors labeled additional 224 healthy palm trees from the rich in palms neighborhood in Omer, Israel, and 53 healthy palm trees from Los Angeles, US.

The inventors used transfer learning on the XResNet model pre-trained on ImageNet, with the fastai library. XResNet is an improved ResNet architecture developed by fastai and based on the work of He et al. XResNet features three tweaks (ResNet-B, C, and D) which He et al. demonstrated to improve model accuracy consistently. The inventors used fastai standard augmentations and progressive resizing for training the model.

To train the classifier, the inventors integrated out-of-domain data, namely images not containing palm trees. Since a classifier will always return a classwith the highest value as classification the inventors included an unknown class to contain such out-of-domain data samples. In fact, Zhang and LeCun has shown that such an approach has an extra regularization effect with supervised learning. To get a variable sample of out-domain-data the inventors used the Caltech 101 dataset. This dataset contains 101 different categories to be used for the “unknown” class. the inventors also added object data samples collected from street view images, including non-palm trees, billboards, cars, etc. To deal with data imbalance, the infested palm trees were oversampled (from 70 to 892) and the Caltech 101 classes were under-sampled uniformly 8 images of each class. The inventors tested the model on palm trees that the inventors manually identified as infested and on images of the same palms prior to infestation. To manually identify infested palm trees the inventors relied on the Food and Agriculture Organization (FAO) guidelines.

According to the guidelines, infested palm trees should have symptoms such as oozing of a brown, viscous liquid from the infestation site, boreholes, large cavities, and even the crown can fall off. Different palm trees have different symptoms. Phoenix canariensis specifically and some types of date palms should have symptoms that are more visible in the crown. For example, they would have holes in the fronds, absence of new fronds, wilting/dying of already developed fronds, and/or an asymmetrical crown. Also, sometimes leaves above the older leaf whorls are dry. Limited by the image resolutions of Google Street View, the inventors focused on detecting symptoms thatare manifested in the palm tree crown.

### Curating an Image Datasets

The inventors curated data for three different tasks:
a. Palm tree detection from aerial imagery: To collect aerial imagery data the inventors used Google Maps. The tiles (images) were collected for a specific geographic area at zoom 20. The image size was 256×256 pixels.
b. Palm tree detection from street-level: To collect street-level data the inventors used Google Street View. Each image has a heading of 90 degrees. The image size was 640×640 pixels.
c. Infested palm tree classification: To collect healthy and infested palm tree images the inventors manually collected images for both classes. Infested palm tree images were collected from various websites utilizing Google Search. Images that represent healthy palm trees were selected manually using images downloaded from Google Street View.

### Evaluating the Method on Test Data

For demonstrating the potential of our proposed method, the inventors were focused on two physical locations reported of having infested palm trees. For evaluation of the method, the inventors choose to focus on the San Diego area since according to a report by Hodel et al. in 2016, an infestation was found in the San Ysidro area of San Diego, and since there are also street view images from the referred period. As another case study for palm tree mapping the inventors chose the small town of Omer, Israel, which contains a high density of palms. Because of its small size andits high density of palm trees, it is a perfect use-case for demonstrating tree mapping from street-level images. To test the performance of our palm mapping methodology, the inventors evaluated three sub scenarios aerial mapping, street-level mapping, and combined method. To test the performance of our infested palm trees detection classifier in urban areas, in real-world conditions, the inventors collected street image data from the San Ysidro, Imperial Beach, Old Town, Petco Park areas. The images for San Ysidro were collected between February 2015 and April 2016, a time periodprior to the date specified in the report. For the other areas, the images were collected from 2018 according to the timestamp on the presented images on the website . The inventors used the street layer supplied by an open street map to extract coordinates that represent the streets. The coordinates were extractedwith a distance of 8 meters between each following point. For each point, the inventors collected the nearest panorama from which the inventors extracted four images in the fields of views of 0, 90, 180, and 270. The inventors then used our palm tree classifier to extractall the palm crowns from the collected street view images and finally classified the crowns to either healthy or infested. To evaluate performance, the inventors searchedfor the trees presented in the reports, 4 as well as additional potentially infected trees.

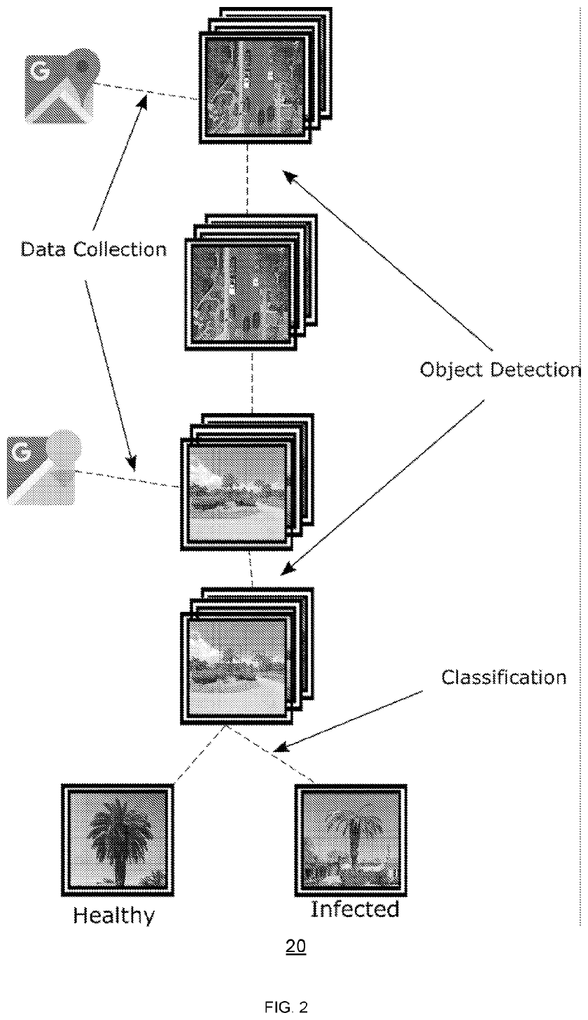

To blindly find newly infested trees for which the inventors had no prior reports (see image 20 of FIG. 2), the inventors used the mentioned above method, by initially detecting the palm trees using aerial imagery, then applying detection and classification on Street View images. Since the search space is enormous, as a proof of concept, the inventors focused on the San Diego area, specifically on neighborhoods where infested trees were found in the past. The usage of aerial images reduces the search space saving time and money. The inventors also inspected additional neighborhoods where residents mention Red Palm Weevil on social media. These raised only recent street view photos from 2019 and 2020 from which the inventors retrieved the newest photos for each location.

To measure the effectiveness of using aerial imagery for reduction of the search face the inventors performed a comparison of both methods. The inventors calculated the required number of street view images to fully, map a specific area. Next, the inventors used the full method on the same area and calculated the number of aerial and street view images the was required to map the same area.

Finally, the inventors also explored the temporal propagation of palm tree infestation, in search of the point in time in which a palm tree was infested. The inventors chose the palm trees that were classified as infested and retrieved their history street viewimages. Since each image may contain multiple trees and repeated street view images are not necessarily taken at the exact same coordinates, the inventors employed the following heuristics to re-center the trees. First, the method calculates the point of view using the newer street-view coordinates and the aerial coordinates using atan2. If the newer street viewpoint is farther from the aerial retrieved coordinates thanthe original street view image method retrieves the image using the calculated point of view. Otherwise, the method calculates the shift of the palm in the image (90*((x_{left}+x_{right})/2)/640 45) and it to the calculated heading. Next, method classified the palm tree past images to detect at which times it was already infested.

### Results

To detect and map Weevil infested palm trees, the inventors collected over 100,000 aerial and Street View images that were online available on the Google Maps platform. Out of the downloaded dataset, the inventors extracted a total of 47,138 aerial 61,009 street-level images of palm trees. Using our proposed methodology, the inventors identified at least 40 palm trees suspected of infestation.

In terms of palm tree detection from downloaded images, the palm tree aerial detector achieved a performance of 0.50 mAP and the street-level palm detector achieved mAP of 0.90. The palm tree health classifier achieved an F1 score of 0.84, precision of 0.83, recall of 0.85, and AUC of 0.948.

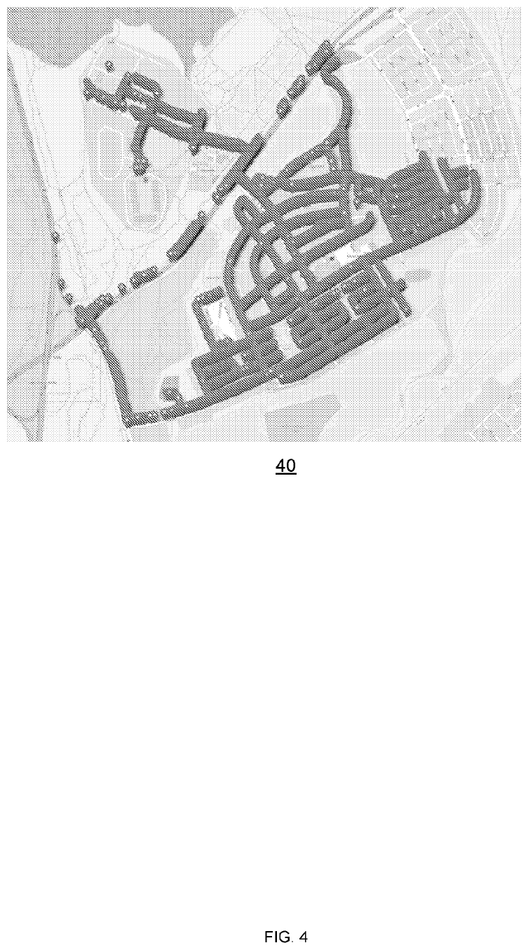

To evaluate the potential of palm tree mapping from street view images the inventors chose a small town highly populated with palms as a use case, in order to demonstrate the strength of the proposed method in identifying infested palms, specifically in urban environments. The inventors download 3,209 panorama images from Google Street View of the small town of Omer, Israel. The inventors were highly successfulin identifying palm trees in 2,609 out of the 3,209 panoramas (see map 40 of FIG. 4), even in this urban setting.

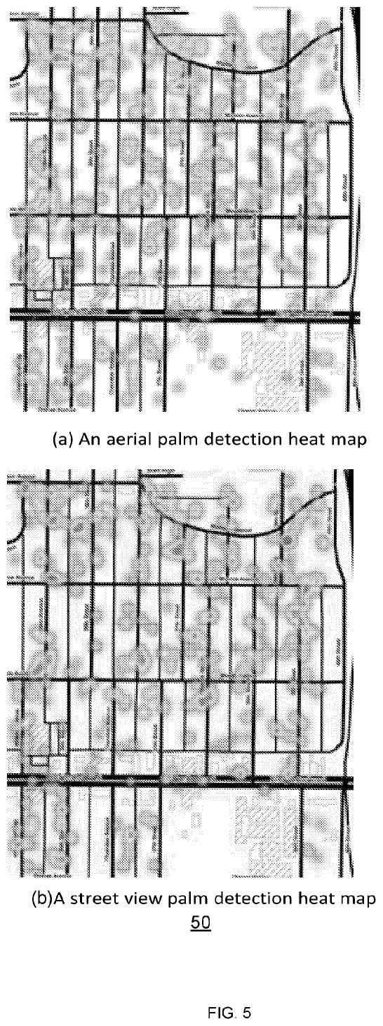

Next, the inventors demonstrate that by using aerial images the method reduces the number of required street view images needed for mapping palm trees in urban areas, significantly reducing our search space. For example, to map palms in a sample neighborhood, namely the Normal Heights Village, San Diego the inventors used 546 aerial images. In these 546 aerial images, the inventors detected 756 palm trees. To map all Normal Heights Village areas using Street View only 1,136 panorama imagesare required, where each panorama is essentially composed of four images (the API only returns a 90-degree point of view each time). Thus the search space is reduced in this example from 1136*4 street view images to 546 street view and 756 aerial images, In FIG. 5 (includes two images collectively denoted 50) the inventors show the comparison of palm tree detection using aerial images only (see FIG. 5(a)) to palm tree detection using Street View after aerial detection (see FIG. 5(b)).

It can be seen the palm tree detection results are highly similar in both cases (72% of palm trees detected using aerial images were confirmed as actual palm trees on street-level imagery), despite thepre-processing step of search space reduction by aerial imagery.

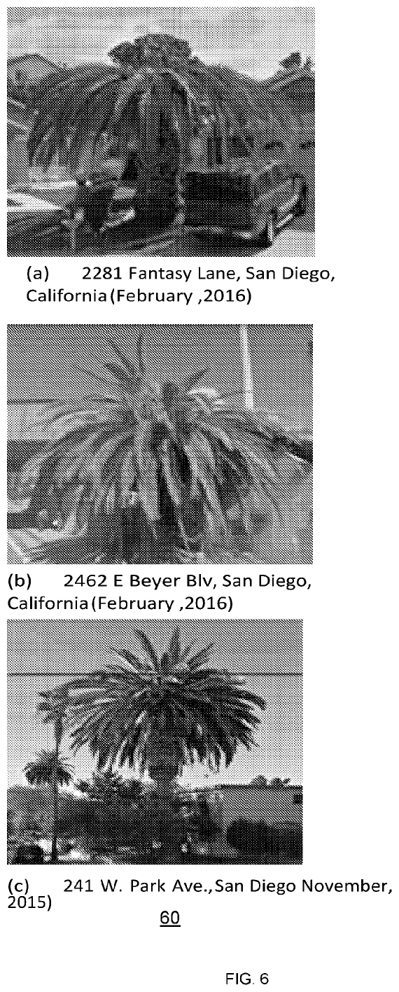

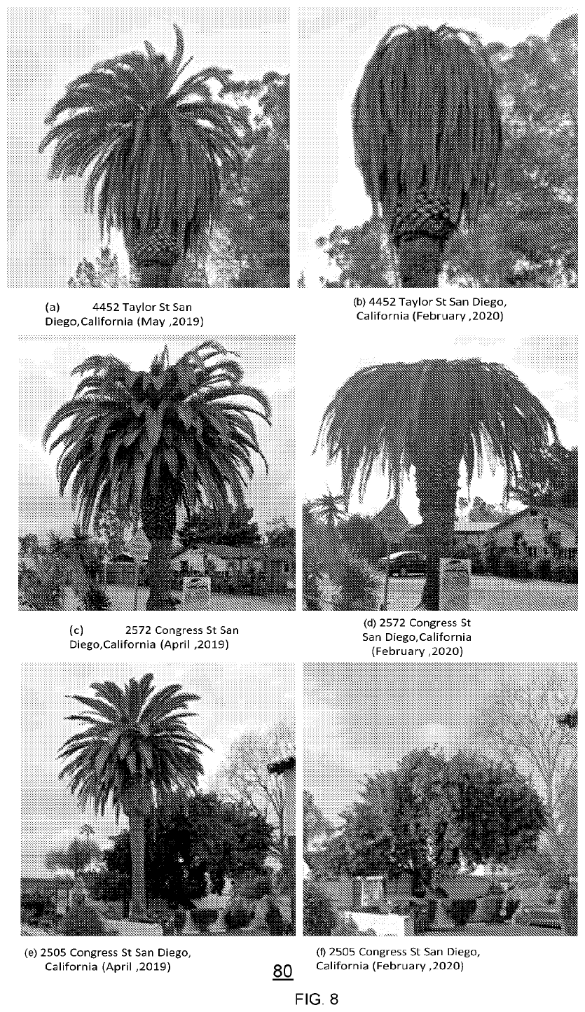

As a proof of concept, the inventors also demonstrate that the suggested method can be used to find actual infested trees in urban areas, using street view imagery. Specifically, out of the four infested palm trees described by Hodel et al. the inventors able to find the exact physical location of three of them (See images 60(1), 60(b) and 60(c)—collectively denoted 60 in FIG. 6). The location of the fourth tree was described with a general location description instead of an address, so could not be confirmed. Hodel et al. reported infested palm trees are dated to March 2016. The nearest images by date in Google street view were dated for two trees to February 2016 and the third three were dated to November 2015. Additionally, the inventors found all three palm trees that had specified location in an online report (see images 80(a), 80(b), 80(c), 80(d), 80(e) and 80(f) collectively denoted 80 of FIG. 8). The classifier classified five of the six trees as infested. Additionally, out of 5,008 detected palms, in the same area, the classifier detected additional 13 infested palm trees, of which the inventors identified eight at advanced infestation stages.

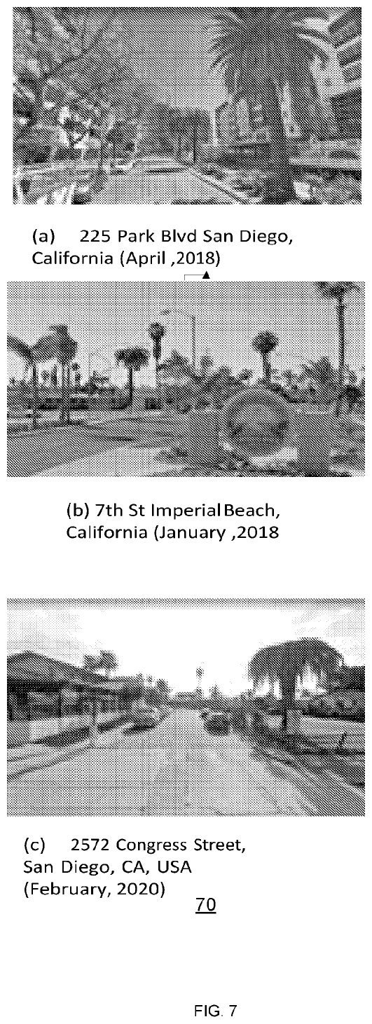

The inventors also wanted to demonstrate the potentially efficiently finding newly infested trees using aerial and street-level imagery combined. the inventors retrieved 22,438 aerial images that lead the inventors to 54,781 street view images. From these images, the inventors found 36,001 palm trees from which 109 were classified as infested from which the inventors identified 24 as an infestation at an advanced stage. Additionally, the inventors demonstrate that the suggested method can be utilized to find between which dates the palm tree was infested. FIG. 7 (included FIGS. 70(a), 70(b) and 70(b) collectively denoted 70 of FIG. 7) illustrates Google Street View images of the infested palm trees presented by Aguilar Plant Care)

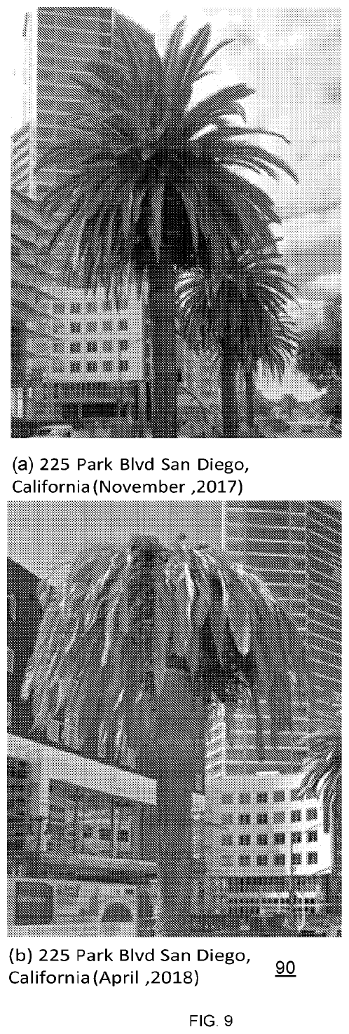

Observing FIG. 9 (including images 90(a) and 90(b) collectively denoted 90), it can be seen that according to our classifier in November 2017 (see FIG. 9(a)) the palm tree still was not infested. However, in April 2018 (see FIG. 9(b)) we identified infestation.

There is provided a framework for large scale mapping and detection of Red Palm Weevil infested palm trees, using state-of-the-art deep learning algorithms. This large scale methodology may be of tremendous financial importance to countries around the world, help in massively saving agricultural fields, and assist in reducing risks of injuries in urban areas. The proposed methodology relies on aerial and street view images available online.

First, the inventors demonstrated how easily can Google Street View images can be used to map palm trees in small cities. In a small town (Omer, Israel) chosen as a suitable use-case, the inventors were able to detect thousands of palms. the inventors detected thousands of palm trees from Omer, Israel street view images. the inventors found that in almost on every street in Omer there is a Palm tree, making this town extremely vulnerable to Red Palm Weevil infestation. Nevertheless, the inventors noted that not all streets of Omer are mapped by Google. The inventors propose that small towns, suchas Omer, may choose to independent annual photoshoot the streets of their municipality, subsequently applying the offered methodology to the newest datato detect newly infested trees and perform preventive pestification to save trees. Additionally, by performing more frequent mapping they can detect an active infestation and monitor its state.

Second, the inventors show how to reduce at least six-fold the number of street view images required for mapping in urban areas, by initially using rough aerial palm tree detection. This translates into saving both money (using each street view image costs 0.007$) and time in data collection and processing. When mapping large areas using aerial images may save thousands of dollars. Our results indicate that the majority (72%) of aerial detected palm trees are of actual palm trees. This number is likely even higher since some palms arenot viewable from the street. Naturally, there are also false positives. In other words, in most cases, there is no need to use all the area street images. Full street mapping is only practical in small cities or when the municipality independently maps the streets, otherwise, the costs using street view could be very high.

Third, the inventors illustrated that the suggested method in general and palm tree health classifier, in particular, can successfully detect infested palm trees. As a sample case, the inventors detected two out three infected palm trees described by Hodel et al. The third reported tree showed only early stages of infestation on Mar. 17, 2016, while the closest street view images dated November 2015. This may explain why it was not detected by the classifier as being infested, likely because it was not yet exhibiting visual signs of infestation. The results indicated that deep learning can be used for detecting infested palm trees. At the current status of the proposed model, it is able to detect severe and medium infections. Future studies may focus on modifying the algorithms to detect various stages of infestation. With more available data for training, as well as access to images of higher resolution, it may be possible to improve the accuracy of detection. By using high-resolution trunk images it may be possible to also detect early infestation signs in a variety of palm tree spices.

Fourth, the inventors detected infested palm trees that were not presented in online reports including areas that were not mentioned in any report. The results clearly show the potential of the method to monitor palm tree infestation worldwide utilizing minimal resources based only on online available data. Urban mapping of palm trees may slow down the spread of infestation and flag areas for pestification. Moreover, theoretically putting costs aside, it is possible to study the spread of the Red Palm Weevil over both time and space areas creating a map of their spreads. Such data may be used to predict the path of the spread in a future infestation.

The suggested method can be implemented to detect a wide range of floral infestations or diseases, specifically any infestation or disease with visual symptoms that can be detected by the naked eye from a distance of several meters. For example, the suggested methodology could be adjusted to detect banana plants infected with Fusarium Wilt. This notion is based on the fact that the symptoms are relatively similar to wilting of the leaves on the top of the plant. Theoretically, the suggested methodology could be applied to every type of tree or plant with every possible visible signs of disease, saving costs and labor required for manual inspection.

It is worth noting that the methods used in this study are prone to several limitations:

First, Google aerial images are not taken at the same time that of street view images, a fact that may lead to missing newly planted palm trees or detection of palm trees that were already cut down. This of course can be solved by obtaining aerial images from multiple time points. However, currently, Google API does not support retrieving older aerial images nor the timestampof the current images.

Second, occasionally the detected palm tree in aerial images does not have a line of sight from the street, thus the inventors will not be ableto acquire its street image. Nevertheless, the inventors will at least know it is there, in contrast to using Street View images only.

Third, a single street view image may contain multiple palm trees, thus often it is hard to determine whetherthe same tree is detected by an aerial versus a street view palm tree detector.

Forth, street view images are not taken at constant time intervals, and only at sporadic time points. This can lead to missing information in some areas at certain times.

Fifth, the number of images of infested palm trees available online is limited. Moreover, most of those images are of palms at advanced infestation stages. This limits the performance of the infestation classifier both in terms of accuracy, as well as on different stages of infestation. Training the classifier on more data with infested trees on different stages should provide better results.

Sixth, there are many types of palm trees and the symptoms of an infestation can be different. Currently, most of the photos the inventors found of infested palm trees are of Cannery Palm trees. With additional data, a specific classifier can be created for each type of palm tree.

Seventh, Google Street View resolution is limited to a resolution of 640×640; in the case of Weevil infestation in Canary palms, this image resolution is sufficient. However, the relatively low image resolution may pose a problem for detecting different pests or other diseases in other plants that require images of finer resolution.

Eighth, When classifying vegetation there may be external or seasonal variables that can affect how the plant looks and as result influence the classifier. Specifically, canary palm trees do not have any fall color change, no specialwinter interest. The only seasonal changes are related to flowering and to the growth of fruits, which seem less likely affect the classification of red palm weevil infestation classification. From an environmental pointof view, canary palm trees may be damaged under 20° F./−6° C. degrees. However, this is unlikely to affect the results of this study since in San Diego, the coolest temperatures are reached in December, and they reach as low as 50° F./10° C. degrees. The inventors do suspect that strong winds might affect the palm tree visually leading to misclassification, but didnot encounter any such cases in the empirically studies examples.

Ninth, the current method and data do not support the detection of borderline cases or detecting the severity of the infestation. One option is to convert the problem to a regression problem and predict a severity score. Also, potentially, it may be possible to use the last layer of the neural network as a feature vector to represent the classified object, in order to measure distances between palm tree representations. Thus, marginal cases could be classified according to the nearest group of classified objects. Another alternative is to utilize the model confidence as a score. However, deep learning models are known to be highly mis-calibrated thus in order to use the probability there is a need to evaluate utilizing algorithms such as MCDropout, QD, Deep K-Nearest Neighbor. Either way, these solutions require ground-truth data to train and evaluate the models. Steps for dealing with uncertainty in deep learning may be applied for predicting the severity of flora disease.

Red Palm Weevil has spread across the world damaging and destroying countless palm trees and date crops. In this study, the inventors developed a novel automatic methodfor the detection and monitoring of Red Palm Weevil infestation by analyzing over 47,000 aerial and 61,000 street views. Utilizing the aerial images, the method filtered by search space by detecting palm trees; then the method analyzed the aerial detected palms from street level view. The inventors demonstrated that this information can be utilized to map palm trees in urban areas and detect and monitor Red Palm Weevil infestation.

The inventors demonstrated that using deep learning and online available data can present an automatic and cost-effective solution for monitoring and detection of pest infestations. Such a solution can help ministries of agriculture and governments worldwide to fight and contain the spread of Red Palm Weevil.

The suggested method is deployable instantly in any scale and every point of the world where there is street view level imagery. Regularly, such a process requires specialized equipment, a long time and effort to be executed on a large scale. In the current state of the Red Palm Weevil spread such a tool is a necessity that can instantly assist with the fight against the Red Palm Weevil.

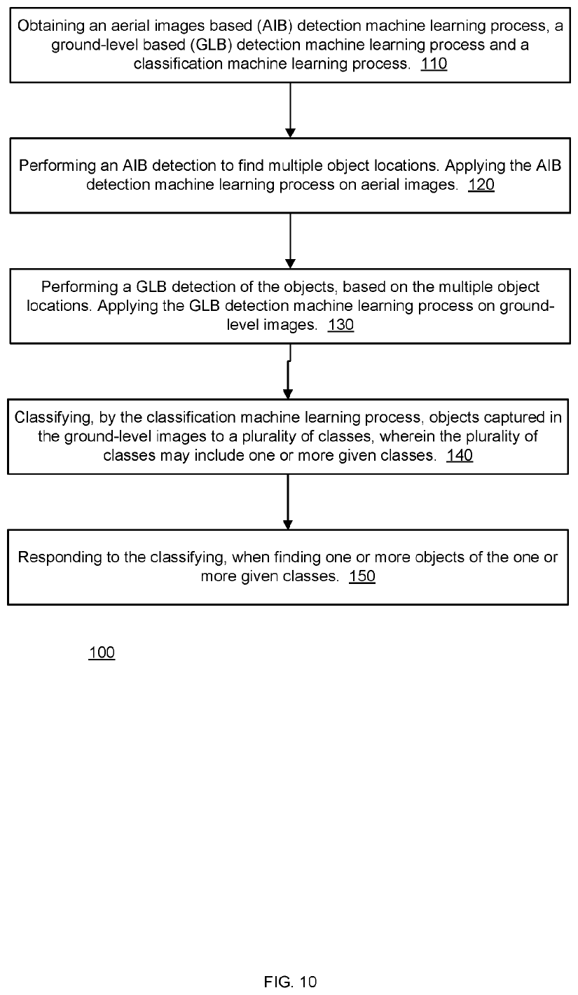

FIG. 10 illustrates an example of a method 100 for detection of objects of one or more given classes.

The method may be used for detection of objects that may be spread over one or more areas. The method may be highly effective when the objects are spread over vast areas—for example over areas that have an aggregate size that may exceed 1, 10, 50, 100, 200, 500, 1000, 2000, 5000, 10,000, 20,000, 50,000, 100,000, 200,000, 500,000, 1,000,000, 2,000,000, 5,000,000, 10,000,000, 20,000,000, 50,000,000, 100,000,000, 200,000,000, 500,000,000 square kilometers.

The method may be highly effective when using vast data bases such as GOOGLE STREET VIEW™, MAPS.ME, GOOGLE MAPS™, OSMAND, AMAP, BAIDU TOTAL VIEW™, SHOWMYSTREET™, OPENSTREETCAM™, EARTH-SCOUT™, MAPCRUNCH™, GOOGLE EARTH™, BRICK STREET VIEW™, EMAPS™, and the like.

A vast database may include millions of images and/or may cover at least some of the one or more vast areas.

Method 100 may start by step 110 of obtaining an aerial images based (AIB) detection machine learning process, a ground-level based (GLB) detection machine learning process and a classification machine learning process.

The obtaining may include receiving one or more of the machine learning processes, training one or more of the machine learning processes, re-training one or more of the machine learning processes, and the like.

Step 110 may be followed by step 120 of performing an AIB detection to find multiple object locations. Step 120 may include applying the AIB detection machine learning process on aerial images.

Step 120 may be followed by step 130 of performing a GLB detection of the objects, based on the multiple object locations. Step 130 may include applying the GLB detection machine learning process on ground-level images.

Step 130 may be followed by step 140 of classifying, by the classification machine learning process, objects captured in the ground-level images to a plurality of classes, wherein the plurality of classes may include one or more given classes. The one or more given classes may be defined in advance and/or defined in any other manner—as classes that may require to respond to their finding. The one or more given classes may be referred to as classes of interest.

Step 140 may be followed by step 150 of responding to the classifying, when finding one or more objects of the one or more given classes.

Step 150 may include responding when finding one or more objects of a class other than the one or more given classes.

The objects may be of any kind—for example—that may be plants and the one or more given class are one or more defective plant classes. The object may differ from plants.

The one or more defective plant classes may be one or more infected plant classes. The infected plant classes may include claims infected with pests, plants infected with a disease, and the like.

The plants may be palm trees and the one or more infected plant classes comprises a Red Palm Weevil infected class.

The plants may differ from palm trees—for example, the plants may include other trees, bushes, weeds, man grown plants, wild plants, and the like.

When searching for infected palm trees (infected by Red Palm Weevil) it may be beneficial to use a classification machine learning process that was trained to search for deformations in palm tree crowns—and the deformation of the palm tree crowns are easier to detect and/or may be executed with lower resolution images—as the deformation of the palm tree crowns are larger than the holes formed in the truck of the palm tree by the Red Palm Weevil.

When classifying plants other than palm trees—it is beneficial to search for infection indicators that are larger by size and/or are more unique to infection.

Step 150 may include at least one out of storing a result of the classifying, transmitting the result of the classifying, generating an alert, calculating a current status of the objects of the one or more given class, requesting to acquire more images of any type, re-training one or more machine learning process based on the classification, updating any parameter of any of the machine learning processes, suggesting and/or executing a counter-measure to a state (current or future) of the objects of the one or more given class, predicting a future state of one or more objects (this may apply to the objects of the one or more given class and/or to other objects), predicting a future progress of Red Palm Weevil infection, suggesting a ground-level image acquisition scheme (this may or may not be based on the future progress of the Red Palm Weevil infection), suggesting an aerial image acquisition scheme, and the like.

The ground-level images may be selected out of sets of ground-level images. For example—the selection may include selecting, out of multiple images associated with a single GOOGLE STREET VIEW acquisition point, an image that includes an object of interest.

The selecting of the ground-level images may be based on spatial relationships (for example direction and optionally direction and distance) between the multiple object locations and ground-level image acquisition locations.

The sets of ground-level images may be still images of may be video streams. For example, a single GOOGLE STREET VIEW™ acquisition point may be associated with a video stream.

At least one of the AIB detection machine learning process, the GLB detection machine learning process, and the classification machine learning process is a deep learning process.

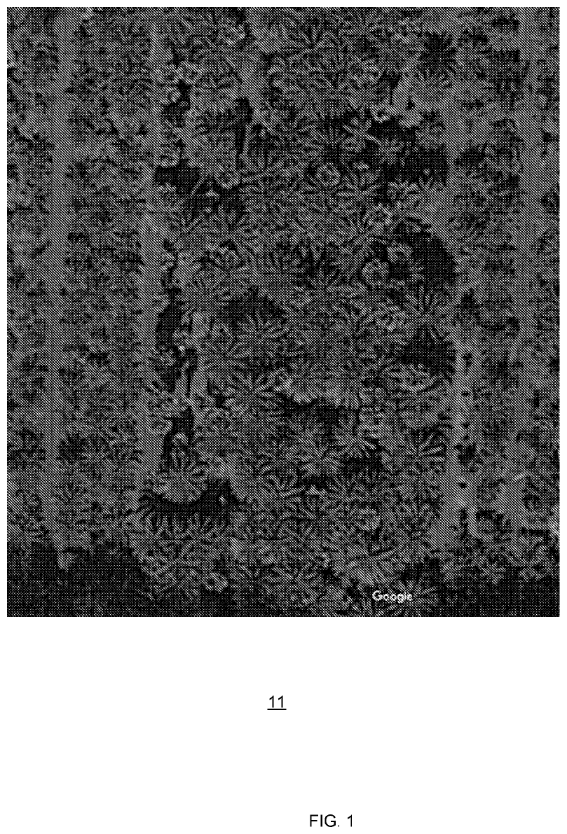

FIG. 1 illustrates an example of a method 200 for detection of objects of one or more given classes.

The method may be used for detection of objects that may be spread over one or more areas. The method may be highly effective when the objects are spread over vast areas.

The method may be highly effective when using vast data bases.

Method 100 differs from method 200 by including a AIB detection step and a GLB detection step—while method 200 includes AIB detection steps. Any reference to method 100 should be applied mutatis mutandis to method 200.

Method 200 may start by step 210 of obtaining a first aerial images based (AIB) detection machine learning process, a second AIB detection machine learning process and a classification machine learning process.

The obtaining may include receiving one or more of the machine learning processes, training one or more of the machine learning processes, re-training one or more of the machine learning processes, and the like.

Step 210 may be followed by step 220 of performing a first AIB detection to find multiple object locations. Step 220 may include applying the first AIB detection machine learning process on first aerial images of up to a first resolution.

Step 220 may be followed by step 230 of performing a second AIB detection to of the objects, based on the multiple object locations. Step 230 may include applying a second AIB detection machine learning process on second aerial images of at up to a second resolution; wherein the second resolution is finer than the first resolution.

Step 230 may be followed by step 240 of classifying, by the classification machine learning process. objects captured in the second aerial images to a plurality of classes, wherein the plurality of classes include the one or more given classes.

The one or more given classes may be defined in advance and/or defined in any other manner—as classes that may require to respond to their finding. The one or more given classes may be referred to as classes of interest.

Step 240 may be followed by step 250 of responding to the classifying, when finding one or more objects of the one or more given classes.

Step 250 may include responding when finding one or more objects of a class other than the one or more given classes.

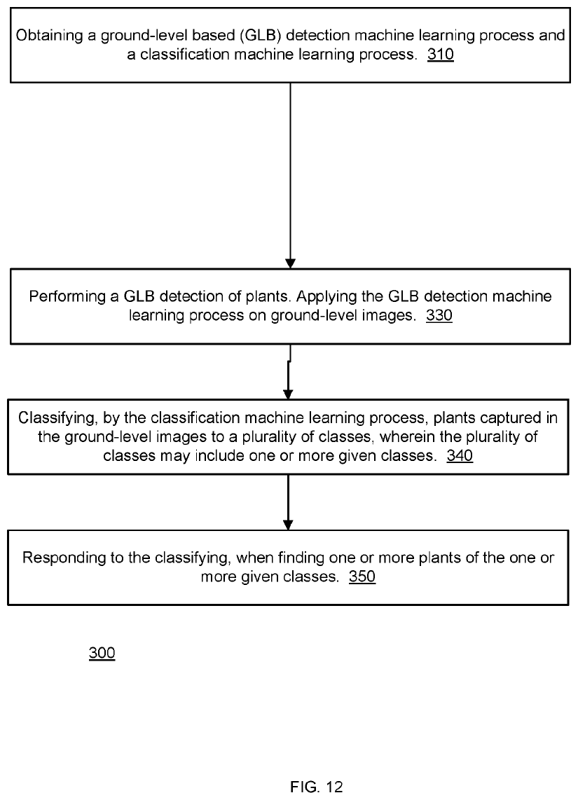

FIG. 12 illustrates an example of a method 300 for detection of plants of one or more given classes.

Method 100 differs from method 300 by including a GLB detection step and aiming to find objects that may or may not be plants—while method 300 does not include a GLB detection step and is aimed to find plants. Any reference to method 100 should be applied mutatis mutandis to method 300.

The method may be used for detection of plants that may be spread over one or more areas. The method may be highly effective when the plants are spread over vast areas.

The method may be highly effective when using vast data bases.

Method 300 may start by step 310 of obtaining a ground-level based (GLB) detection machine learning process and a classification machine learning process.

The obtaining may include receiving one or more of the machine learning processes, training one or more of the machine learning processes, re-training one or more of the machine learning processes, and the like.

Step 310 may be followed by step 330 performing a GLB detection of the plants. Step 330 may include applying the GLB detection machine learning process on ground-level images.

Step 330 may be applied based on multiple locations of the plants—or at least based on areas to be examined but may be executed without prior knowledge of the locations.

Step 330 may be followed by step 340 of classifying, by the classification machine learning process, plants captured in the ground-level images to a plurality of classes, wherein the plurality of classes may include one or more given classes. The one or more given classes may be defined in advance and/or defined in any other manner—as classes that may require to respond to their finding. The one or more given classes may be referred to as classes of interest.

Step 340 may be followed by step 350 of responding to the classifying, when finding one or more plants of the one or more given classes.

Step 350 may include responding when finding one or more plants of a class other than the one or more given classes.

Figure & illustrates an example of a computerized system 400 configured to execute one or more of methods 100, 200 or 300.

Computerized system 400 may include one or more computers such as one or more servers, one or more laptops, one or more desktops, a data center, and the like.

Computerized system may include a memory unit 410, one or more processing circuits 420 and a communication unit 430.

The processing circuits may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A non-transitory computer readable medium for detection of objects of one or more given classes, the non-transitory computer readable medium stores instructions for:
performing an aerial images based (AIB) detection to find multiple object locations; wherein the performing of the AIB detection comprises applying an AIB detection machine learning process on aerial images;
performing a ground-level based (GLB) detection of the objects, based on the multiple object locations; wherein the performing of the GLB detection comprises applying a GLB detection machine learning process on ground-level images; and
classifying, by a classification machine learning process, objects captured in the ground-level images to a plurality of classes, wherein the plurality of classes comprise the one or more given classes; and
responding to the classifying, when finding one or more objects of the one or more given classes.

2. The non-transitory computer readable medium according to claim 1, wherein the objects are plants and wherein the one or more given class are one or more defective plant classes.

3. The non-transitory computer readable medium according to claim 2, wherein the one or more defective plant classes are one or more infected plant classes.

4. The non-transitory computer readable medium according to claim 3, wherein the plants are palm trees and wherein the one or more infected plant classes comprises a Red Palm Weevil infected class.

5. The non-transitory computer readable medium according to claim 4, wherein the classification machine learning process was trained to search for deformations in palm tree crowns.

6. The non-transitory computer readable medium according to claim 4, wherein the responding comprises predicting a future progress of Red Palm Weevil infection.

7. The non-transitory computer readable medium according to claim 6, wherein the responding comprises suggesting a ground-level image acquisition scheme based on the future progress of the Red Palm Weevil infection.

8. The non-transitory computer readable medium according to claim 1, wherein the responding comprises suggesting a ground-level image acquisition scheme.

9. The non-transitory computer readable medium according to claim 1, wherein at least some of the aerial images belong a vast aerial images database.

10. The non-transitory computer readable medium according to claim 1, wherein at least some of the ground-level images belong a vast ground-level images database.

11. The non-transitory computer readable medium according to claim 1, wherein at least some of the ground-level images are street view images of a vast online street view images database.

12. The non-transitory computer readable medium according to claim 1, wherein the ground-level images are selected out of sets of ground-level images.

13. The non-transitory computer readable medium according to claim 12, wherein a selecting of the ground-level images is based on spatial relationships between the multiple object locations and ground-level image acquisition locations.

14. The non-transitory computer readable medium according to claim 13, wherein the sets of ground-level images are video streams.

15. The non-transitory computer readable medium according to claim 1, wherein at least one of the AIB detection machine learning process, the GLB detection machine learning process, and the classification machine learning process is a deep learning process.

16. The non-transitory computer readable medium according to claim 1, wherein the objects are spread over one or more vast areas.

17. A detection system for detection of objects of one or more given classes, the system comprises a one or more processing circuits that are configured to stores instructions for:
perform an aerial images based (AIB) detection to find multiple object locations; wherein the performing of the AIB detection comprises applying an AIB detection machine learning process on aerial images;
perform a ground-level based (GLB) detection of the objects, based on the multiple object locations; wherein the performing of the GLB detection comprises applying a GLB detection machine learning process on ground-level images; and
classify, by a classification machine learning process, objects captured in the ground-level images to a plurality of classes, wherein the plurality of classes comprise the one or more given classes; and
responding to the classifying, when finding one or more objects of the one or more given classes

18. A method for detection of objects of one or more given classes, the method comprises:
performing an aerial images based (AIB) detection to find multiple object locations; wherein the performing of the AIB detection comprises applying an AIB detection machine learning process on aerial images;
performing a ground-level based (GLB) detection of the objects, based on the multiple object locations; wherein the performing of the GLB detection comprises applying a GLB detection machine learning process on ground-level images; and
classifying, by a classification machine learning process, objects captured in the ground-level images to a plurality of classes, wherein the plurality of classes comprise the one or more given classes; and
responding to the classifying, when finding one or more objects of the one or more given classes.

19. The method according to claim 18, wherein the objects are plants and wherein the one or more given class are one or more defective plant classes.

20. The method according to claim 19, wherein the one or more defective plant classes are one or more infected plant classes.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
